(19) United States
(12) Patent Application Publication
(10) Pub. No.: US 2006/0167391 A1
(43) Pub. Date: Jul. 27, 2006

(54) Buccodental care device

(76) Inventor: Joseph Ohayon, Paris (FR)

Correspondence Address: E Joseph Gass;Burns Doane Swecker & Mathis, PO Box 1404, Alexandria, VA, 22313-1404, US

(21) Appl. No.: 10/548,662

(22) PCT Filed: Mar. 8, 2004
(86) PCT No.: PCT/IB04/01230

§ 371 Date: Sep. 9, 2005

(30) Foreign Application Priority Data
Mar. 10, 2003 (FR) 03 02955

(51) Int. Cl. A61H 13/00

(52) U.S. Cl. 601/165; 601/162; 601/160

(57) ABSTRACT

The invention relates to a buccodental care device. It relates to a device, comprising in combination a flushing cleaning device, comprising a liquid supply, a flushing device and a cannula, sucking discharge device, comprising a cannula, a sucking device and a liquid vessel and a control device for controlling the simultaneious operation of the flushing and sucking devices. The flushing cleaning device is a hydropulsion device. Each cannula has a handle and a setting valve which can be actuated by the hand holding the handle. Application to old, invalid or disabled people.

The present invention relates to buccodental care, and more particularly, a buccodental care device specially designed for bedridden or invalid people but also appropriate for any other people.

Administering buccodental care in institutions such as hospitals, private hospitals, old people's homes, geriatrics and disabled people homes, involves special problems. Indeed, traditional brushing is often uneasy, even impossible. For example, it is not convenient for bedridden people.

It is already known to use hydropulsion devices flushing through a cannula liquid jets allowing for some tooth cleaning. The liquid being flushed by such devices should be able to be discharged. Such a discharge is no problem when the individual is standing and can for example spit into a washbasin. However, such a solution is not possible for bedridden people. In practice, such hydropulsion devices are not used for bedridden people to be cared of.

It is also known, in the dental care art, to use sucking devices comprising a cannula, most often being curved, for providing a continuous discharge of saliva and fluids which could be spread out by drills or other instruments.

Such solutions, being implemented in a dentist's office, obviously are not convenient for the daily buccodental care in bedridden patients, who are often unable to perform by themselves the basic operations required for such care.

The object of the present invention is to provide a solution for overcoming such above-mentioned buccodental care problems. More precisely, the invention relates to a device wherein cleaning teeth, mucous membranes and mouth generally can be done by one single individual, without any help from the bedridden individual. More precisely, the device according to the invention combines on the one hand a cleaning, function through flushing a cleaning liquid and on the other hand a discharge function for the liquid being flushed.

Preferably, the discharge function starts before the flushing function and continues after the completion of the flushing function, such so that the individual's mouth remains clear.

More precisely, the invention relates to a buccodental care device comprising, in combination, a flushing cleaning device, comprising a liquid supply, a flushing device and a flushing cannula, a sucking discharge device, comprising a sucking cannula, a sucking device and a liquid vessel, and a control device so as to control at least the simultaneous operation of the flushing device and the sucking device.

Preferably, the flushing device has a pulsating operation. Thus, it is advantageous when the flushing cleaning device is a hydropulsion device.

Preferably, each cannula has a handle and a setting valve arranged so as to be actuated by the hand holding the handle. Preferably, the cannulas have a single-use nozzle or are exchangeable. The sucking cannula could be bent so as to allow to be labially held.

In an advantageous embodiment, the flushing device and the sucking device are driven by the same driving force source. It should then be advantageously an electric motor.

In another embodiment, the driving force source of the sucking device is a compressed air venturi creating a depression provided for the sucking device.

In an embodiment, the control device comprises a programmed device. It is then advantageous when it control, in first time periods, the simultaneous operation of the flushing and sucking devices and, in second time periods, the only operation of the sucking device.

In an embodiment, the device is portable and is designed to be connected with an electric current source. The electric current source could be for example a supply network, an accumulator battery, a battery or a combination thereof.

In another embodiment, the device is moveable on a carriage comprising an independent energy source, and in another embodiment, the device is stationary and is designed for being mounted near a bed.

Other characteristics and advantages of the invention will be better understood from reading the following specification of embodiments made referring to the accompanying drawings wherein:

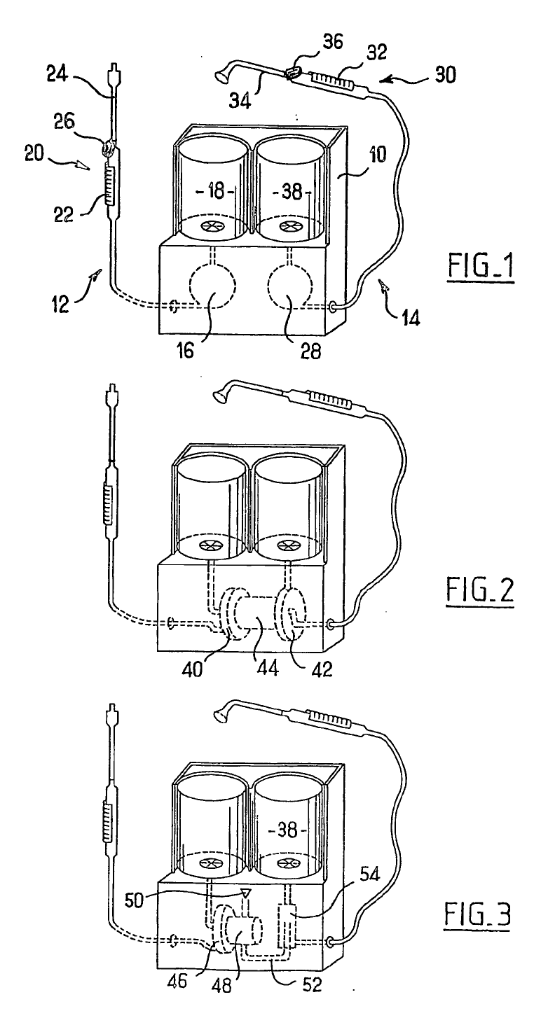

FIG. 1 shows an exemplary buccodental care device according to a first embodiment of the invention;

FIG. 2 shows an alternative device only having one motor; and

FIG. 3 shows another embodiment of a device which can be advantageously used in the case of a pneumatic supply, being sometimes present in some institutions.

FIG. 1 shows a device according to a first embodiment of the invention. Such a device comprises a housing 10 containing the functional components for the device. Such functional components essentially comprise a flushing cleaning device generally designated by 12 and a sucking discharge device with the general numeral 14.

More precisely, the flushing cleaning device 12 comprises a pump 16 drawing from a supply 18 a liquid, such as water or a solution containing a mouth-wash product. The pump outlet is connected with a flushing cannula 20 comprising a handle 22 and a nozzle 24 adapted to be put into the mouth. The nozzle 24 could be of a single use or preferably exchangeable type. A button 26 controls a valve allowing for the flushing performed by means of the cannula to be set.

The sucking cleaning device 14 comprises a sucking pump 28 sucking through the cannula 30 provided with a handle 32 with a nozzle 34. The nozzle 34 is preferably bent so that it could optionally remain hanged up on a lip. The cannula 30 may optionally comprise a button 36 for setting a valve allowing for the sucking force to be set. The materials being extracted by the cannula 30 are discharged by the pump 28 into the vessel 38.

The device additionally comprises a control device, not shown, also arranged in the housing 10. It could comprise appropriate switches. The control device is not shown, as it could have numerous known forms, ranging from simple switches separately controlling the pumps 16 and 28 to programmable microprocessor systems for performing very elaborate coordinated control cycles of the operations of the cleaning and discharge devices.

In a particularly advantageous embodiment of the invention, a simple command to the control circuit provides the sucking function by the cannula 30 before the flushing function by the cannula 20 starts. In such a way, the discharge of the materials from the mouth immediately occurs and prevents liquid from stagnating deep in the throat creating some discomfort to the patient. Similarly, the sucking device 14 goes on running for some time, preferably a few seconds, after the flushing cleaning device 12 has stopped, so that all the liquids which have possibly spread out in the mouth are discharged and the patient feels comfortable.

FIG. 2 shows an alternative wherein both pumps 16 and 28, each driven by a motor in the embodiment in FIG. 1, are coupled with one single motor 44. In such an embodiment, it could be advantageous either to incorporate a solenoid valve into the flushing cannula circuit, so as to be able to programme various simultaneous or not cleaning and discharge cycles, or to incorporate clutches between the motor and each of the pumps or one of the pumps 40, 42 at least. Such an embodiment provides a reduced cost for the device.

The device in FIG. 3 is another alternative which is advantageously used in the case of stationary facilities, for example, at the top of a hospital bed. It is frequent that compressed air should be available near a hospital bed. In such a case, the device comprises for the cleaning device a pump 46 being driven by a pneumatic motor 48 connected with a compressed air inlet 50 located at the mounting location of the device. The compressed air going out of the motor 48 through a line 52 is supplied to a venturi device 54 the side sucking part of which is connected with a sucking cannula such that the sucked liquids are discharged into the vessel 38.

The devices in FIGS. 1 and 2 are advantageously of the portable type. When the motors driving the pumps 16, 28 and the motor 44 are of an electric type, they could be supplied through a connection with the mains, by an accumulator battery, for example of the nickel-cadmium type, by a battery or a combination thereof.

In an alternative useful in institutions such as hospitals, private hospitals, old people's homes, etc., the device could be mounted on a carriage with an accumulator battery. It could then be moved from one bed to another by the caregiver in order to provide the buccodental care of several individuals successively.

One of the main features of the device according to the invention is that it does not require any discharge, as the liquid being used for cleaning purpose is recovered by the sucking device. It is therefore not required to have a wash-basin available to use the device. The device could be easily moved in such institutions and makes it possible for buccodental care of patients, old people, invalid or disabled people to be performed by one single individual, in a simple and easy way.

Although it has been essentially referred to the case of bedridden people, the invention is also applicable to other patients, for example having their jawbones immobilized and which do not provide an easy access to the mouth after a fracture, setting or osteosynthesis.

Obviously, various modifications could be provided by the man of the art to the devices being just disclosed only by way of non limiting examples without departing from the scope of the invention.

1. A buccodental care device, of the kind which comprises in combination:
a flushing cleaning device, comprising a liquid supply and a flushing device,
a sucking discharge device, comprising a sucking device and a liquid vessel, and
a control device designed for controlling the operation of the flushing device and the sucking device,
wherein
the flushing cleaning device is a hydropulsion device,
the flushing device includes a flushing cannula, and
the control device is designed for controlling at least the simultaneous operation of the flushing device and the sucking device.

2. A device according to claim 1, wherein the sucking discharge device comprises a sucking cannula.

3. A device according to claim 2, wherein at least one of the flushing cannula and the sucking cannula has a handle and a setting valve arranged so as to be actuated by the hand holding the handle.

4. A device according to claim 1, wherein the flushing device and the sucking device are driven by the same driving source.

5. A device according to claim 4, wherein the driving source is an electric motor.

6. A device according to claim 1, wherein the control device comprises a programmed device.

7. A device according to claim 6, wherein the programmed device controls, in first time periods, the simultaneous operation of the flushing and sucking devices and, in second time periods, the only operation of the sucking device.

8. A device according to claim 1, wherein the cannulas have a single use nozzle.

9. A device according to claim 1, wherein the device is portable and is designed for being connected with an electric current source selected amongst a mains, an accumulator battery, a battery and a combination thereof.

10. A device according to claim 1, wherein the device is moveable on a carriage comprising an independent energy source.

11. A device according to claim 2, wherein the flushing device and the sucking device are driven by the same driving source.

12. A device according to claim 2, wherein the control device comprises a programmed device.

13. A device according to claim 4, wherein the control device comprises a programmed device.

14. A device according to claim 2, wherein the cannulas have a single use nozzle.

15. A device according to claim 4, wherein the cannulas have a single use nozzle.

16. A device according to claim 6, wherein the cannulas have a single use nozzle.

17. A device according to claim 2, wherein the device is portable and is designed for being connected with an electric current source selected amongst a mains, an accumulator battery, a battery and a combination thereof.

18. A device according to claim 6, wherein the device is portable and is designed for being connected with an electric current source selected amongst a mains, an accumulator battery, a battery and a combination thereof.

19. A device according to claim 2, wherein the device is moveable on a carriage comprising an independent energy source.

20. A device according to claim 6, wherein the device is moveable on a carriage comprising an independent energy source.
